(19) United States
(12) Patent Application Publication
(10) Pub. No.: US 2018/0196811 A1
(43) Pub. Date: Jul. 12, 2018

(54) SYSTEMS AND APPARATUSES FOR SEARCHING FOR PROPERTY LISTING INFORMATION BASED ON IMAGES

(71) Applicant: Move, Inc., Westlake Village, CA (US)

(72) Inventors: Fenjun ZHANG, Westlake Village, CA (US); Adam BOWRON, Westlake Village, CA (US); Xiaodian XU, Westlake Village, CA (US); Lance KEARSEY, Westlake Village, CA (US); Tamara DUKAI, Westlake Village, CA (US); Scott RUTHERFORD, Westlake Village, CA (US); Lauren KAHN, Westlake Village, CA (US)

(21) Appl. No.: 15/870,461

(22) Filed: Jan. 12, 2018

Related U.S. Application Data
(60) Provisional application No. 62/445,563, filed on Jan. 12, 2017.

(51) Int. Cl. G06F 17/30; G06Q 50/16; H04W 4/02; G06K 9/34

(52) U.S. Cl. CPC G06F 17/30047; G06F 17/30268; G06K 2209/01; H04W 4/025; G06K 9/344; G06Q 50/16

(57) ABSTRACT

Apparatuses, methods, and systems disclosed herein that utilizes camera images captured by user devices to identify a property listing from a plurality of property listing in a database. In one example embodiment, a method is provided comprising accessing or receiving, from a device, at least one image, and obtaining one or more words contained in the image. Location information associated with the device may also be obtained. Thereafter, causing to query a set of records associated with the image based on the obtained one or more words contained in the image and the location information of the device. In some embodiments, after receiving from the set of records, one or more matching records, details from the received one or more matching records is displayed on the device.

### CROSS REFERENCE TO RELATED APPLICATIONS

This application claims the benefit of U.S. Provisional Patent Application No. 62/445,563 filed Jan. 12, 2017, the entire contents of which are incorporated herein by reference.

### TECHNOLOGICAL FIELD

The present invention relates to searching for real estate data, and more specifically, to utilizing camera images captured by user devices to identify a property listing from a plurality of property listing in a database.

### BACKGROUND

The process of searching for a new home or renting an apartment is a major undertaking for a potential home buyer or renter and often includes repetitive, boring browsing at hundreds of property listings and organizing potential properties. Another major consideration is researching neighborhoods before relocating. Potential home buyers will often visit neighborhoods and drive around looking for available homes. If a buyer is out exploring a neighborhood and sees a property that interests the buyer, it may be difficult for the buyer to obtain and review information about the property at that moment. Conventional systems, which include websites configured to either (1) present a list of properties that are ranked and presented in some order unknown to a user, often without the input of user-specific criteria; or (2) overlay some indications of potential listings on a map, which requires heavy bandwidth and data usage on a mobile device. To identify or concretely determine a listing that matches a desired property, the conventional process may involve many steps for the buyer such as looking for a street sign to identify the address of the home, inputting the address into a web browser, and viewing and filtering through hundreds of search results which in the end may not provide accurate information on the property. This is both time-consuming and laborious for the buyer.

As described in detail below, the inventors have developed a versatile mobile application for overcoming the problems presented by convention systems and processes. Accordingly, the mobile application may use the camera features and/or various sensors of a mobile device to capture an image of a real estate property's sale sign to quickly query and retrieve listing information about the property the buyer is viewing in real-time.

### BRIEF SUMMARY

Apparatuses, methods, and systems disclosed herein improve the process of searching for a property and retrieving more information about that property. Fundamentally, example embodiments described herein rely on the fact that users of mobile devices equipped with cameras and physical sensors has become a ubiquitous feature of society. Accordingly, example embodiments facilitate a convenient and quick way to obtain accurate property listing information that a user is physically looking at while exploring the neighborhood of that property.

In example embodiments, various methods, apparatuses, and systems are provided that facilitate improved query and retrieval of property listing information. For example, example embodiments involve, accessing or receiving, from a device, at least one image, and obtaining one or more words contained in the image. Location information associated with the device may also be obtained. A set of records may then be queried for one or more matching records associated with the image based on the obtained one or more words contained in the image and the location information of the device. In some embodiments, after receiving, from the set of records, one or more matching records, details from the received one or more matching records is displayed on the device.

Although described using an example method above, an apparatus is also contemplated herein associated with the device. The apparatus includes at least one processor and at least one memory comprising instructions that when executed by a processor, cause the apparatus to access or receive, from a device, at least one image, obtain one or more words contained in the image, obtain location information of the device, cause to query a set of records associated with the image based on the obtained one or more words contained in the captured image and the location information of the device, receive, from the set of records, one or more matching records, and cause display of details from the received one or more matching records on the device.

Similarly, an example computer program product is also contemplated herein. The computer program product includes a non-transitory computer readable storage medium comprising instructions that, when executed by a device, configure the device to access or receive, from a device, at least one image, obtain one or more words contained in the image, obtain location information of the device, cause to query a set of records associated with the image based on the obtained one or more words contained in the captured image and the location information of the device, receive, from the set of records, one or more matching records, and cause display of details from the received one or more matching records on the device.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 is a schematic representation of a system that may support example embodiments of the present invention;

FIG. 2 is a block diagram of an electronic device that may be configured to implement example embodiments of the present invention;

FIG. 3 is a block diagram of an mobile device that may be embodied by or associated with an electronic device, and may be configured to implement example embodiments of the present invention;

FIG. 4 is a flowchart illustrating operations performed by a device in accordance with example embodiments of the present invention;

FIGS. 5 and 6 are schematic representations of user interfaces which may be displayed in accordance with example embodiments of the present invention.

### DETAILED DESCRIPTION

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., one or more volatile or non-volatile memory device), can be differentiated from a “computer-readable transmission medium,” which refers to an electromagnetic signal.

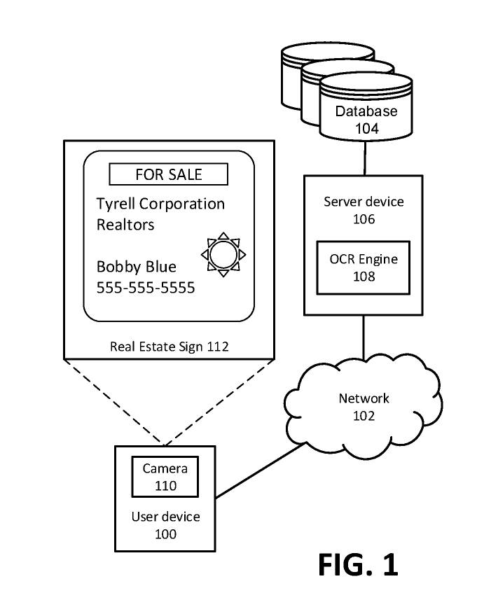

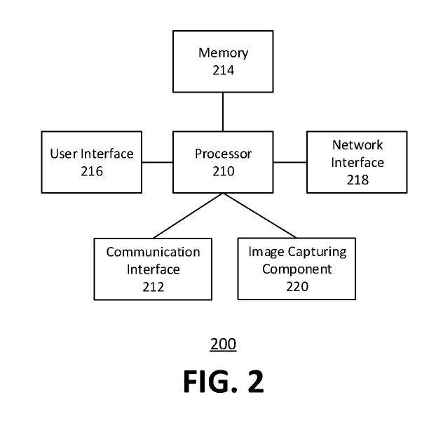

Reference is now made to FIG. 1 which illustrates a user device 100 connected to a network 102. FIG. 1 also illustrates that in some embodiments, a server device 106 may also be connected to the network 102. The device 100 may be configured to communicate over any type of network. For example, the device 100 may be a mobile terminal, such as a mobile telephone, PDA, pager, laptop computer, tablet computer, smart phone, wearable display device, or any of numerous other hand held or portable communication devices, computation devices, content generation devices, content consumption devices, or combinations thereof. In accordance with some embodiments, the device 100 may include or be associated with an apparatus 200, such as that shown in FIG. 2 and described below.

FIG. 1 shows the device 100 includes a camera 110. A user carrying device 100 may point camera 110 of device 100 at any scene and/or physical object. In one embodiment, the user points camera 110 at a physical real estate sign 112 and captures the real estate sign as an image snapshot. In some implementations, the real estate sign 112 is captured as part of a live camera feed. The real estate sign 112 includes text indicating a property for sale, the real estate agent's name, and contact information of the real estate agent and/or management company. The image snapshot or live camera feed capture of the real estate sign as captured by camera 110 of device 100 can be transmitted to the server device 106.

In some embodiments, server device 106 may include an OCR engine 108 to perform an optical character recognition (OCR) process on image data captured from the real estate sign. OCR engine 108 includes a recognition algorithm that determines one or more character sequences of the real estate sign 112 based on data stored in a database 104. In another embodiment, the server device 106 may receive the captured image from the user device 100 via the network 102. The server device 106 compares the one or more character sequences or text strings recognized in the image, using the OCR engine, with phrases or text strings in database 104, and causes to display at least one property listing result to the user. The server device 106 is further configured to rank search results based on the highest number of data points which is explained in more detail below. In some embodiments, the server device 106 is configured to perform error correction on the recognized character sequence or text before it is used for matching and/or presenting search results to the user. In yet another embodiment, the recognized character sequence or text may be presented to the user device 100 before subsequent processing so as to confirm the correctness of the character sequence or text.

As shown in FIG. 1, device 100 may communicate with one or more server device 106) via network 102. Network 102 may be a wireless network, such as a Long Term Evolution (LTE) network, an LTE-Advanced (LTE-A) network, a Global Systems for Mobile communications (GSM) network, a Code Division Multiple Access (CDMA) network, e.g., a Wideband CDMA (WCDMA) network, a CDMA2000 network or the like, a General Packet Radio Service (GPRS) network, Wi-Fi, HSPA (High Speed Packet Access), HSPA+ (High Speed Packet Access plus) network, or other type of network.

Furthermore, FIG. 1 illustrates the system configured to receive data from a variety of databases (e.g. a property database, a supplier database, a product database, etc.) At least a portion of a set of records of each database is processed to determine a match to a received query using image data captured from user device 100. For purposes of example, database 104 comprises property listing data which may be any data and/or information relating to directly or indirectly to a real estate property. A real estate property, such as a home (e.g., single-family house, duplex, apartment, condominium, etc.), a commercial property, an industrial property, a multi-unit property, etc. Real estate data may include, but is not limited to, textual descriptions of the property, property price, property layout, property size, the street address of the property, the selling history of the property, data relating to neighboring sold properties, textual remarks relating to the property, data contained on a property condition form, audio comments relating to the property, inspection reports of the property, surveys and/or site maps of the property, photographs of various portions of the property, a video and/or virtual tour of the property, a video and/or virtual tour of the neighborhood, a video and/or virtual walk-through of the property, a video and/or virtual walk-through of the neighborhood, etc. Property data may also include data regarding whether the property is for sale. Such information is associated with a real estate listing service such as a Multiple Listing Service (MLS) information.

Because database 104 stores detailed information associated with a plurality of real estate properties, when a device initiates a property search request via capturing an image of the real estate for sale sign, the device can query database 104 for property listing information and possibly other related information associated with the property listing. Property listing information may be provided directly to the user device via the server device via network 102 in response to provision of identifying words and/or text and the location information of the device gathered from the captured image from the user device 100. The server device 106 may retrieve property listing information associated with the identifying data and cause to transmit for display the property listing information on the user device 100.

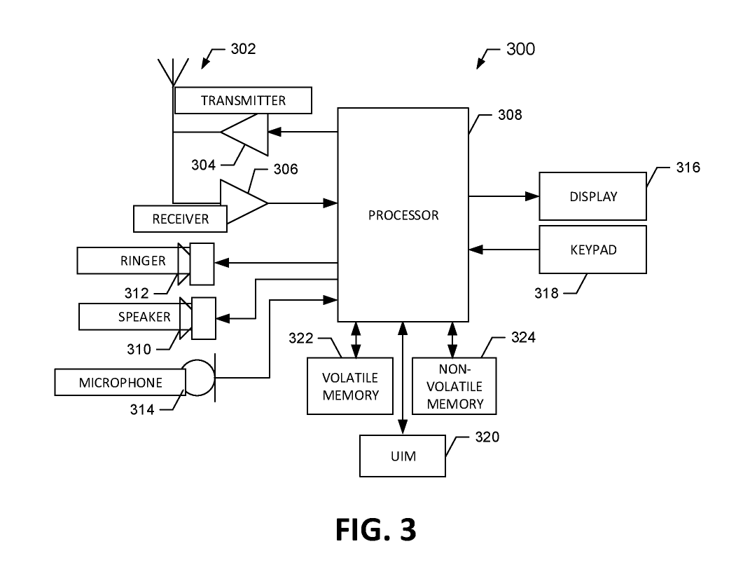

Referring now to FIG. 2, an apparatus 200 is illustrated that may comprise device 100 and/or server device 106. Apparatus 200 includes constituent components including, but not necessarily limited to, a processor 210, a communication interface 212, a memory 214, and a user interface 216. In some embodiments, the processor 210 (and/or co-processors or any other processing circuitry assisting or otherwise associated with the processor 210) may be in communication with memory 214. The memory 214 may include, for example, one or more volatile and/or non-volatile memories. In other words, for example, the memory 214 may be an electronic storage device (e.g., a computer readable storage medium) comprising gates configured to store data (e.g., bits) that may be retrievable by a machine (e.g., a computing device like the processor 210). In some embodiments, the memory 214 may have constituent elements 322 and 324, which are referenced below in connection with FIG. 3. The memory 214 may be configured to store information, data, content, applications, instructions, or the like, for enabling the apparatus to carry out various functions in accordance with an example embodiment of the present invention. For example, the memory 214 could be configured to buffer input data for processing by the processor 210. Additionally or alternatively, the memory 214 could be configured to store instructions for execution by the processor 210. Specifically, the memory 214 may have stored thereon a snap property sign application (or “app”) that, upon execution, configures the apparatus 200 to provide the functionality described herein.

The apparatus 200 may, in some embodiments, be embodied by or associated with a mobile terminal (e.g., mobile terminal 300, which is described in greater detail below in connection with FIG. 3). In these or other embodiments, the apparatus 200 may be embodied as a chip or chip set. In other words, the apparatus 200 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 200 may therefore, in some cases, be configured to implement an embodiment of the present invention on a single chip or as a single “system on a chip.” As such, in some cases, a chip or chipset may constitute means for performing one or more operations for providing the functionalities described herein.

The processor 210 may be embodied in a number of different ways. For example, the processor 210 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 50 may include one or more processing cores configured to perform independently. A multi-core processor may enable multiprocessing within a single physical package. Additionally or alternatively, the processor 210 may include one or more processors configured in tandem via a bus to enable independent execution of instructions, pipelining and/or multithreading. In embodiments in which the apparatus 200 is embodied as mobile terminal 300 shown in FIG. 3, the processor 210 may be embodied by the processor 308.

The processor 210 may be configured to execute instructions stored in the memory 214 or otherwise accessible to the processor 210. Alternatively or additionally, the processor 210 may be configured to execute hard coded functionality. As such, whether configured by hardware or software methods, or by a combination thereof, the processor 210 may represent an entity (e.g., physically embodied in circuitry) capable of performing operations described herein, and thus may be physically configured accordingly. Thus, for example, when the processor 210 is embodied as an ASIC, FPGA or the like, the processor 210 may include specifically configured hardware for conducting the operations described herein. Alternatively, as another example, when the processor 210 is embodied as an executor of software instructions, the instructions may specifically configure the processor 210 to perform the algorithms and/or operations described herein when the instructions are executed. For instance, when the processor 210 is a processor of a specific device (e.g., a mobile terminal or network entity) configured to embody the device contemplated herein (e.g., user device 100 or server device 106) that configuration of the processor 210 occurs by instructions for performing the algorithms and/or operations described herein. The processor 210 may include, among other things, a clock, an arithmetic logic unit (ALU) and logic gates configured to support operation of the processor 210.

Processor 210 may further control an image capturing component 220 comprising an optical and/or acoustical sensor, for instance a camera and/or a microphone. An optical sensor may for instance be an active pixel sensor (APS) and/or a charge-coupled device (CCD) sensor. The image capturing component 220 may be attached to or integrated in apparatus 200.

Meanwhile, the communication interface 212 may be any means such as a device or circuitry embodied in either hardware or a combination of hardware and software that is configured to receive and/or transmit data from/to a network, such as network 102, and/or any other device or module in communication with the apparatus 200. In this regard, the communication interface 212 may include, for example, an antenna (or multiple antennas) and supporting hardware and/or software for enabling communications with a wireless communication network. Additionally or alternatively, the communication interface 212 may include the circuitry for interacting with the antenna(s) to cause transmission of signals via the antenna(s) or to handle receipt of signals received via the antenna(s). In some environments, the communication interface 212 may alternatively or also support wired communication. As such, for example, the communication interface 212 may include a communication modem and/or other hardware/software for supporting communication via cable, digital subscriber line (DSL), universal serial bus (USB) or other mechanisms. For instance, when the apparatus 200 comprises a mobile terminal such as that shown in FIG. 3, the communication interface 212 may be embodied by the antenna 302, transmitter 304, receiver 306, or the like.

In some embodiments, such as instances in which the apparatus 200 is embodied by device 100, the apparatus 200 may include a user interface 216 that may, in turn, be in communication with the processor 210 to receive an indication of a user input and/or to cause provision of an audible, visual, mechanical or other output to the user. As such, the user interface 216 may include, for example, a keyboard, a mouse, a joystick, a display, a touch screen(s), touch areas, soft keys, a microphone, a speaker, or other input/output mechanisms. Alternatively or additionally, the processor 210 may comprise user interface circuitry configured to control at least some functions of one or more user interface elements such as, for example, a speaker, ringer, microphone, display, and/or the like. The processor 210 and/or user interface circuitry comprising the processor 210 may be configured to control one or more functions of one or more user interface elements through computer program instructions (e.g., software and/or firmware) stored on a memory accessible to the processor 210 (e.g., memory 214, and/or the like).

In some embodiments, device 100 may be embodied by mobile terminals. In this regard, a block diagram of an example of such a device is mobile terminal 300, illustrated in FIG. 3. It should be understood that the mobile terminal 300 is merely illustrative of one type of user device that may embody devices 100 and 104. As such, although numerous types of mobile terminals, such as PDAs, mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, may readily be used in some example embodiments, other user devices including fixed (non-mobile) electronic devices may be used in some other example embodiments.

The mobile terminal 300 may include an antenna 302 (or multiple antennas) in operable communication with a transmitter 304 and a receiver 306. The mobile terminal 300 may further include an apparatus, such as a processor 308 or other processing device (e.g., processor 50 of the apparatus of FIG. 3), which controls the provision of signals to, and the receipt of signals from, the transmitter 304 and receiver 306, respectively. The signals may include signaling information in accordance with the air interface standard of an applicable cellular system, and also user speech, received data and/or user generated data. In this regard, the mobile terminal 300 is capable of operating with one or more air interface standards, communication protocols, modulation types, and access types. By way of illustration, the mobile terminal 300 is capable of operating in accordance with wireless communication mechanisms. For example, mobile terminal 300 may be capable of communicating in a wireless local area network (WLAN) or other communication networks, for example in accordance with one or more of the IEEE 802.11 family of standards, such as 802.11a, b, g, or n. As an alternative (or additionally), the mobile terminal 300 may be capable of operating in accordance with any of a number of first, second, third and/or fourth-generation cellular communication protocols or the like. For example, the mobile terminal 300 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as evolved UMTS Terrestrial Radio Access Network (E-UTRAN), with fourth-generation (4G) wireless communication protocols (e.g., Long Term Evolution (LTE) or LTE-Advanced (LTE-A) or the like.

In some embodiments, the processor 308 may include circuitry desirable for implementing audio and logic functions of the mobile terminal 300. For example, the processor 308 may be comprised of a digital signal processor device, a microprocessor device, and various analog to digital converters, digital to analog converters, and other support circuits. Control and signal processing functions of the mobile terminal 300 are allocated between these devices according to their respective capabilities. The processor 308 thus may also include the functionality to convolutionally encode and interleave message and data prior to modulation and transmission. The processor 308 may additionally include an internal voice coder, and may include an internal data modem. Further, the processor 308 may include functionality to operate one or more software programs, which may be stored in memory. For example, the processor 308 may be capable of operating a connectivity program, such as a conventional Web browser. The connectivity program may then allow the mobile terminal 300 to transmit and receive Web content, such as location-based content and/or other web page content, according to a Wireless Application Protocol (WAP), Hypertext Transfer Protocol (HTTP) and/or the like, for example.

The mobile terminal 300 may also comprise a user interface including an output device such as a conventional earphone or speaker 310, a ringer 312, a microphone 314, a display 316, and a user input interface, all of which are coupled to the processor 308. The user input interface, which allows the mobile terminal 300 to receive data, may include any of a number of devices allowing the mobile terminal 300 to receive data, such as a keypad 318, a touch screen display (display 316 providing an example of such a touch screen display) or other input device. In embodiments including the keypad 318, the keypad 318 may include the conventional numeric (0-9) and related keys (#, *), and other hard and soft keys used for operating the mobile terminal 25. Alternatively or additionally, the keypad 318 may include a conventional QWERTY keypad arrangement. The keypad 318 may also include various soft keys with associated functions. In addition, or alternatively, the mobile terminal 300 may include an interface device such as a joystick or other user input interface. Some embodiments employing a touch screen display, as described further below, may omit the keypad 318 and any or all of the speaker 310, ringer 312, and microphone 314 entirely. The mobile terminal 300 further includes a battery, such as a vibrating battery pack, for powering various circuits that are required to operate the mobile terminal 300, as well as optionally providing mechanical vibration as a detectable output.

The mobile terminal 300 may further include a user identity module (UIM) 320. The UIM 320 is typically a memory device having a processor built in. The UIM 320 may include, for example, a subscriber identity module (SIM), a universal integrated circuit card (UICC), a universal subscriber identity module (USIM), a removable user identity module (R-UIM), etc. The UIM 320 typically stores information elements related to a mobile subscriber. In addition to the UIM 320, the mobile terminal 300 may be equipped with memory. For example, the mobile terminal 300 may include volatile memory 322, such as volatile Random Access Memory (RAM) including a cache area for the temporary storage of data. The mobile terminal 300 may also include other non-volatile memory 324, which may be embedded and/or may be removable. The memories may store any of a number of pieces of information, and data, used by the mobile terminal 200 to implement the functions of the mobile terminal 300.

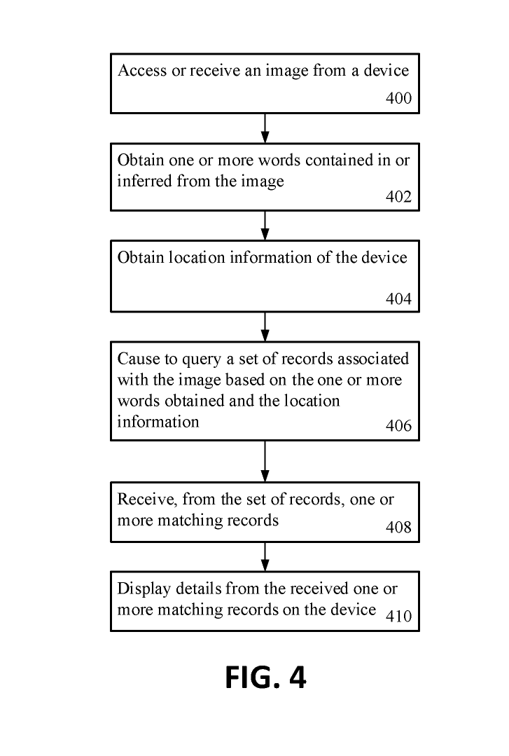

Thus, turning now to FIG. 4, the operations facilitating use of device 100 will now be described. The operations of FIG. 4 may be performed by an apparatus 200, such as shown in FIG. 2, which may comprise a mobile station 300, as described in greater detail in FIG. 3. In this regard, the apparatus 200 may include means, such as a processor 210, memory 214, communication interface 212, and/or user interface 216 for executing operations described herein.

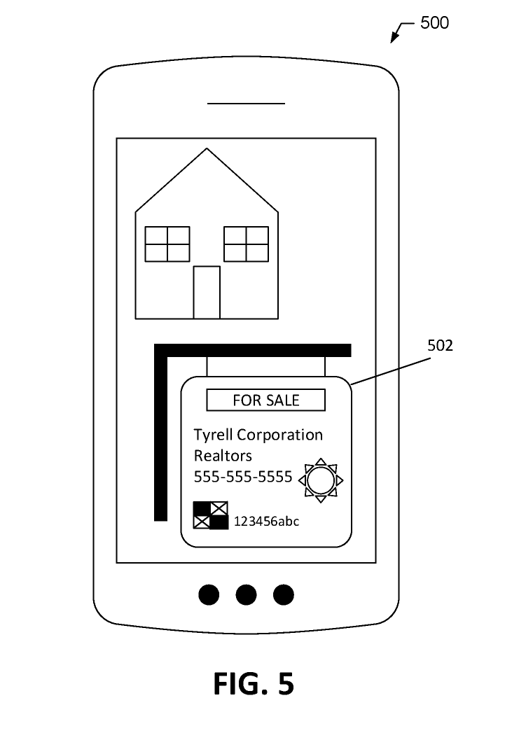

Returning to the specific operations of the device 100, the device 100 using the snap property sign app provides a series of possible procedures to the user. One of these procedures is to initiate a search request for one or more matching records from a database. In the following example embodiment, a search request with at least one image is used. In block 400, an image is accessed or received from the device. The image may have been captured by an image capturing component 220 of apparatus 200. The image capturing component 220 comprises at least an optical sensor configured to capture still images such as image 500 in FIG. 5 or a capture of a frame image from a video. A portion of the captured image may comprise, for example, a traditional real estate “For Sale” sign placed in a window or in a front yard. This physical sign depends upon users to either take the time upon seeing the sign to further investigate the property or make a mental note of information contained in the sign to investigate later. Consequently, there is a need for a method to provide additional property listing information to the user based on the information provided by the sign without needing additional effort or further investigation on the part of the user. The sign may comprise information pertaining to the property and/or a unique identifier imprinted thereon such as QR (Quick Response) code that can store information. Captured image 500 may be then stored as a historical record in a data container according to a JPEG format or any other suitable format in memory 214 of apparatus 200 for later reference.

Using computer vision technology, appropriate software-based readers, and/or various barcode systems to read said unique identifier, the device 100 using the snap property sign app can automatically send the captured image to be analyzed by the server device 106 and OCR engine 108. The server device 106 will use the OCR engine 108 to recognize images, character sequences, or text strings in the detected regions of the captured image. In other words and as depicted in block 400, the device 100 obtains the one or more words contained in or inferred from the image. The one or more words obtained are recognized using optical character recognition (OCR) technology performed by the OCR engine 108. In some embodiments, this optical character recognition technology may be undertaken by the apparatus 200 itself equipped with the OCR engine or OCR software or may be undertaken by the OCR engine 108, associated with the server device 106. Moreover, context information can be inferred by the size, color, or shape of the sign, in addition to the one or more words explicitly contained in the sign. For example, the user device 100 using the snap property sign app or server device 106 may perform error correction in a low light environment to the captured image. The user device 100 using the snap property sign app or server device 106 may analyze and generate inferred labels for elements such as size, shape, color, etc., of the sign. Such inferences can be retained in the data container with the recognized text from the OCR engine. In one example embodiment, the recognized text is supplemented with the inferred labels. The server device 106 is configured to analyze the recognized text and shapes in the captured image data and supplement missing characters not captured (i.e., cut-off in the image capture) so that the intended character sequence or text string may then be used in forming the query. Once the optical character recognition is complete and/or unstructured data is inferred from the context of the sign, the words contained within the real estate sign and/or inferred labels are obtained and used to cause a database 104 query for a property indicated by or associated with the captured image. In one embodiment, the server device 106 is configured to normalize the data used for the query in order to find the most accurate match for the captured image data. In another example embodiment, the server device 106 performs a phonetic fuzzy search to match the query data to one or more “sounds-like” candidates in the database 104. The phonetic fuzzy search may be performed by using a phonetic key or value that is generated based on the data in the query string.

Moreover, in addition to receiving property identifying information, the device 100 may further obtain location information of the device 100 as shown in block 404. The location information may include, but is not limited to, neighboring property names, street data, global positioning system (GPS) data, positioning systems data, and/or longitude and latitude data. The location information determination may include, but is not limited to, GPS, Assisted GPS, cell tower based location determination, Wi-Fi access points, or RFID based location determinations.

Once the one or more words contained in or inferred from the captured image and the location information of the device is obtained, the apparatus 200, device 100 using the snap property sign app may cause to query a set of records from a database associated with the captured image based on the one or more words obtained and the location information as shown in block 406 which may return, from the set of records, one or more matching records in accordance with block 408. Details from the received one or more matching records can then be displayed on the device 100 (block 410). For example, the realtor.com app may launch on the device and display detail information such as real estate property data on the device or the detailed information may be displayed on the snap property sign app of user device 100.

The server device 106 and/or user device 100 using the snap property sign app may use any number of techniques to rank search result before being presented to the user. The recognition algorithm of server device 106 to which may also be included via the snap property sign app may be configured to treat all captured data and location information as equally important, such that the more data matched will have the highest number of data points indicating a confidence level of the search results. For example, returning a property listing result matching the name of the real estate agent of the property, the phone number of the real estate agent, and the location of the user has a higher point value than a property listing result matching only the name of the real estate company and the location of the user. The server device 106 and/or user device 100 using the recognition algorithm, will rank the property listing search results based on the calculated data point value. In another embodiment, the captured data or location information may be weighted such that, for example, the location provides a higher weighted point value than a match on the real estate property company name.

In another embodiment, only the location information of the device 100 may be used to cause a database query for one or more matching records. In yet another embodiment, only the obtained one or more words contained in the captured image may be used to cause a database query for the one or more matching records.

The app can also support other types of recognition techniques. Depending upon what is captured and/or inferred from the image, different types of recognition may be effective in acquiring one or more matching records from one or more databases. For instance, a landscape recognition technique may be used to recognize characteristics in a landscape such as a lawn, shrubbery, trees, or other objects one would typically associate with landscape scenes. In one embodiment, the captured image may contain a lawn with a landscaping service lawn sign advertising the gardening service who performed landscaping on the lawn captured in the image. In addition to utilizing the words in the landscaping service lawn sign to identify the associated gardening service as described in the processes herein, the app can also support a landscape recognition technique to identify the characteristics of the lawn and use the characteristics to query for the gardening service associated with the lawn.

In another embodiment, a facial recognition technique may identify the presence of facial characteristics to be used in the query for one or more matching records. The earlier described landscaping service lawn sign may contain a portrait of the gardener. Using a facial recognition algorithm, the portrait may be analyzed and used to match the facial characteristics identified in the sign to a record of the gardener of the landscaping service in the database.

In yet another further embodiment, the app may use an object recognition technique which may analyze object characteristics such as color, shape, size, or other features associated with an object detected in the image to aid in the accuracy of the received records from the one or more databases. Depending upon what is contained and/or inferred in the image, different types of recognition may be utilized. Using all or some of the recognition techniques described above assure the received one or more matching records is relevant.

In some implementations, the received one or more matching records comprises matching carried out by either exact matching or near matching to the query based on the obtained one or more words contained in and/or inferred from the image and/or location information of the device.

The above described functions may be carried out in many ways. For example, an advertisement may be captured of a landscaping service which can be analyzed to retrieve detailed information on the landscaping company and their available services.

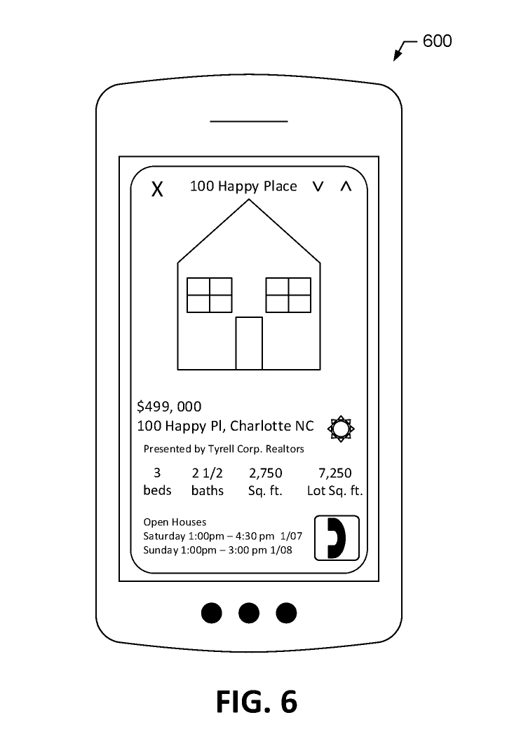

FIG. 6 shows an example information screen that visually presents the property listing information. The screen displays text and images of the property, property price, property layout, property size, street address of the property, open house schedule, and contact information.

In some embodiments the user device 100 provides a type of photo repository for the captured images. Users have the ability to go back and view the saved images in memory 214 and reprocess the image to retrieve details from the received one or matching records. For example, the user may browse through their photos, the historical record of photos and select a particular image. Thereafter, the device may prompt the user with the option to launch the realtor.com app or the snap property sign app so as to display the property listing on the display of the user device 100. The user device 100 also enables the user to save, delete, change or update all photos and property listings found, and the order of their presentation.

The server device 106 may manage the records generated by the device 100. Also, the server device may provide services for data analysis and trend prediction. In one embodiment, the server device 106 may perform statistical analyses of the data provided by the device 100 and data retrieved in order to evaluate the popularity of property listings, neighborhoods, etc.

Certain embodiments of the app may deliver information to other applications executing on the device 100. For example, in one embodiment, the device 100 may automatically deliver open house schedules to the calendar module of the device.

As noted above, searching for a new home can be quite an undertaking for a potential home buyer and can become a monotonous task of browsing at hundreds of property listings. Certain embodiments of the app takes advantage of a user casually driving through a neighborhood searching for a home by utilizing the user's mobile camera to capture a real estate property sign and retrieving property listing information at just one click of the camera.

It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or enhanced. Furthermore, in some embodiments, additional optional operations may be included. Modifications, additions, or enhancements to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
accessing or receiving, from a device, at least one image;
obtaining one or more words contained in the image;
obtaining location information of the device;
causing to query a set of records associated with the image based on the obtained one or more words contained in the image and the location information of the device;
receiving, from the set of records, one or more matching records; and
causing display of details from the received one or more matching records on the device.

2. The method of claim 1, wherein obtaining the one or more words contained in the image comprises identifying results from optical character recognition.

3. The method of claim 1, wherein the location information of the device comprises at least one of property names, street data, global positioning system (GPS) data, positioning systems data, longitude and latitude data.

4. The method of claim 1, wherein the set of records from a database is hosted by a third party device located remotely from the device.

5. The method of claim 1, wherein the details from the received one or more matching records comprises property listing information including one or more of a summary of property features, interior photos of the property, video files, listing price, and contact information.

6. The method of claim 1, further comprising storing the at least one image so as to later retrieve the details from the one or more matching records.

7. An apparatus comprising at least one processor and at least one memory, the memory comprising instructions that, when executed by a processor, configure the apparatus to:
access or receive, from a device, at least one image;
obtain one or more words contained in the image;
obtain location information of the device;
cause to query a set of records associated with the image based on the obtained one or more words contained in the image and the location information of the device;
receive, from the set of records, one or more matching records; and
cause display of details from the received one or more matching records on the device.

8. The apparatus of claim 7, wherein obtaining the one or more words contained in the image comprises identifying results from optical character recognition.

9. The apparatus of claim 7, wherein the location information of the device comprises at least one of property names, street data, global positioning system (GPS) data, positioning systems data, longitude and latitude data.

10. The apparatus of claim 7, wherein the set of records from a database is hosted by a third party device located remotely from the device.

11. The apparatus of claim 7, wherein the details from the received one or more matching records comprises property listing information including one or more of a summary of property features, interior photos of the property, video files, listing price, and contact information.

12. The apparatus of claim 7, further comprising storing the at least one image so as to later retrieve the details from the one or more matching records.

13. A computer program product comprising a non-transitory computer readable storage medium, the non-transitory computer readable storage medium comprising instructions that, when executed by a device, configure the device to:
access or receive, from a device, at least one image;
obtain one or more words contained in the image;
obtain location information of the device;
cause to query a set of records associated with the image based on the obtained one or more words contained in the image and the location information of the device;
receive, from the set of records, one or more matching records; and
cause display of details from the received one or more matching records on the device.

14. The computer program product of claim 13, wherein obtaining the one or more words contained in the image comprises identifying results from optical character recognition.

15. The computer program product of claim 13, wherein the location information of the device comprises at least one of property names, street data, global positioning system (GPS) data, positioning systems data, longitude and latitude data.

16. The computer program product of claim 13, wherein the set of records from a database is hosted by a third party device located remotely from the device.

17. The computer program product of claim 13, wherein the details from the received one or more matching records comprises property listing information including one or more of a summary of property features, interior photos of the property, video files, listing price, and contact information.

18. The computer program product of claim 13, wherein the instructions further comprise instructions that, when executed by the device, are configured to store the at least one image so as to later retrieve the details from the one or more matching records.
